(19) United States
(12) Patent Application Publication
(10) Pub. No.: US 2018/0203399 A1
(43) Pub. Date: Jul. 19, 2018

(54) FINISHER AND IMAGE FORMING SYSTEM

(71) Applicant: KONICA MINOLTA, INC., Tokyo (JP)

(72) Inventor: Akira TSUNODA, Kanagawa-ku Yokohama-shi Kanagawa (JP)

(21) Appl. No.: 15/874,472

(22) Filed: Jan. 18, 2018

(30) Foreign Application Priority Data
Jan. 19, 2017 (JP) 2017-007263

(51) Int. Cl. G03G 15/00

(52) U.S. Cl. CPC G03G 15/6576

(57) ABSTRACT

A finisher corrects curl of a sheet with a decurler which includes: an endless belt; a pushing shaft which pushes the endless belt; an upstream guide which guides the sheet between the endless belt and the pushing shaft; and a downstream guide which guides the sheet. The upstream guide includes: an upstream movable guide which follows motion of the pushing shaft; and an upstream fixed guide which covers the upstream side of the upstream movable guide. The curvature radius of the conveying route of the sheet which is guided by the upstream and downstream guides is set to a value greater than or equal to a reference curvature radius which is set in accordance with the sheet as a threshold value of whether a permanent distortion is formed in the sheet by the conveying route.

### CROSS-REFERENCE TO RELATED APPLICATIONS

The present application claims priority under 35 U.S.C. § 119 to Japanese Patent Application No. 2017-007263, filed on Jan. 19, 2017, the entire contents of which are incorporated herein by reference.

### BACKGROUND

### Technological Field

The present invention relates to a finisher and an image forming system.

### Description of the Related art

In the past, it has been proposed to correct curl of a sheet in accordance with a curling amount by adjusting a pushing amount by which a member is pushed into the sheet (for example, refer to Japanese Patent Published Application No. 2006-290506).

### SUMMARY

However, in the case of the prior art technique described in Japanese Patent Published Application No. 2006-290506, there is a fear that a sheet may be caught by a gap between guide members during conveying the sheet. Furthermore, in the case of this prior art technique, there is a fear that additional unintended curl may be formed anew in conveyance routes in the upstream and downstream sides of the member provided for adjusting curl. Accordingly, the above prior art technique is in a situation where it is not possible to improve the paper conveying performance and the decurl performance.

Taking into consideration the above circumstances, it is an object of the present invention therefore to improve the paper conveying performance and the decurl performance.

To achieve at least one of the abovementioned objects, according to an aspect of the present invention, a finisher reflecting one aspect of the present invention corrects curl of a sheet with a decurler which comprises: an endless belt; a pushing shaft which pushes the endless belt; an upstream guide which is located in an upstream side of the pushing shaft to guide the sheet between the endless belt and the pushing shaft; and a downstream guide which is located in a downstream side of the pushing shaft to guide the sheet in the downstream direction from the endless belt, the upstream guide comprising: an upstream movable guide which follows motion of the pushing shaft; and an upstream fixed guide which is arranged in an upstream side of the upstream movable guide to cover the upstream side of the upstream movable guide, wherein a curvature radius of a conveying route of the sheet which is guided by each of the upstream guide and the downstream guide is set to a value which is greater than or equal to a reference curvature radius in accordance with the sheet, and wherein the reference curvature radius is set in accordance with the sheet as a threshold value of whether or not a bending stress is applied to form a permanent distortion in the sheet by the conveying route of the sheet.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic view for showing an example of the overall configuration of an image forming system 1 of an embodiment.

FIG. 2 is a view for showing an exemplary structure of a decurler 111 in detail.

FIG. 3 is a view for explaining the pushing amount M of a pushing shaft 241.

FIG. 4 is a view for explaining the correlation between decurling force and the conveying length of a sheet P.

FIG. 5 is a view for explaining the correlation between decurling amount and stress application time.

FIG. 6 is a view for explaining the condition of an endless belt 204 which is bent by the pushing shaft 241.

FIG. 7 is a view for explaining the bending stress σ applied to a sheet P by the pushing shaft 241.

FIG. 8 is a schematic diagram for showing the positional relationship among an upstream guide 211, a downstream guide 213 and the pushing shaft 241 in the case where the curvature radius R of the conveying route of a sheet P is smaller than a reference curvature radius R′.

FIG. 9 is a schematic diagram for showing variation examples of the positional relationship among the upstream guide 211, the downstream guide 213 and the pushing shaft 241 in relation to the pushing angle β.

FIG. 10 is a view for schematically explaining the correlation among the curvature radius R of the conveying route of a sheet P, the pushing angle β and the bending stress σ applied to the sheet P.

FIG. 11 is a side view for showing the positional relationship among the upstream guide 211, the downstream guide 213 and the pushing shaft 241 when the pushing angle β of the pushing shaft 241 is 100°.

FIG. 12 is a perspective view for showing the positional relationship among an upstream fixed guide 211A, a downstream movable guide 213A and the pushing shaft 241 when the pushing angle β of the pushing shaft 241 is 100°.

FIG. 13 is a side view for showing the positional relationship among the upstream guide 211, the downstream guide 213 and the pushing shaft 241 when the pushing angle β of the pushing shaft 241 is 12°.

FIG. 14 is a perspective view for showing the positional relationship among the upstream fixed guide 211A, the downstream movable guide 213A and the pushing shaft 241 when the pushing angle β of the pushing shaft 241 is 12°.

FIG. 15 is a schematic view for showing an example in which a resin guide 211A_1 is provided at the downstream end portion of the upstream fixed guide 211A.

FIG. 16 is a schematic view for showing an example in which are provided a plurality of upstream movable guides 211B and a plurality of downstream movable guides 213A.

FIG. 17 is a view for showing an exemplary structure of a conventional decurler 1111.

### DETAILED DESCRIPTION OF THE EMBODIMENTS

Hereinafter, one or more embodiments of the present invention will be described with reference to the drawings. However, the scope of the invention is not limited to the disclosed embodiments.

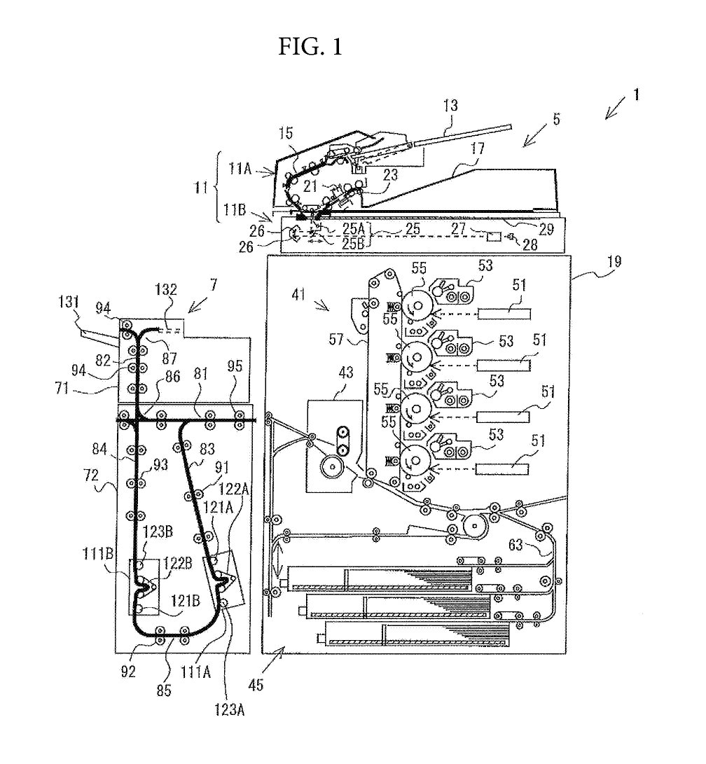

FIG. 1 is a schematic view for showing an example of the overall configuration of an image forming system 1 of the present embodiment. As shown in FIG. 1, the image forming system 1 is provided with an image forming apparatus 5 and a finisher 7. The image forming apparatus 5 is provided with an image reading unit 11 and an image forming apparatus body 19. The image reading unit 11 is provided with an ADF 11A and an original reading unit 11B. The ADF 11A is provided with an original tray 13, a paper path 15, a catch tray 17, a contact image sensor 21, a density reference member 23 and the like. The density reference member 23 is used to perform shading compensation of the ADF 11A. The original reading unit 11B is provided with an original illuminating unit 25, a reflection mirror 26, a condenser lens 27, a sensor 28, a platen glass 29 and the like. The image reading unit 11 separates and delivers originals set on the original tray 13 one by one, conveys the originals in the subscanning direction along the paper path 15 on which the contact image sensor 21 is arranged, and discharges the originals onto the catch tray 17. The original illuminating unit 25 is provided with a lamp 25A and a mirror 25B. While an original is conveyed in the subscanning direction along the paper path 15, an reading operation is repeatedly performed on a line-by-line basis in the main scanning direction with the original illuminating unit 25, the reflection mirror 26, the condenser lens 27 and the sensor 28.

The image forming apparatus body 19 is provided with an image forming unit 41, a fixing unit 43, a paper feed unit 45 and the like. The image forming unit 41 is provided with exposing devices 51, development apparatuses 53, photoreceptor drums 55 and an intermediate transfer belt 57. The image forming unit 41 supplies different color toners to the photoreceptor drums 55 for development with the exposing devices 51 based on image data of an original which is read by the image reading unit 11. The image forming unit 41 transfers toner images developed on the photoreceptor drums 55 to a sheet P supplied from the paper feed unit 45 through the intermediate transfer belt 57. The image forming unit 41 fixes a color image on the sheet P by melting the toner images transferred to the sheet P with the fixing unit 43.

The finisher 7 is arranged in the downstream side of the image forming apparatus 5 to correct curl of a sheet P. The finisher 7 is provided with a housing 71 and a housing 72. In the housing 71, a sheet P corrected within the housing 72 is conveyed to the paper discharge route 82 by rollers 94. The sheet P to be discharged is conveyed through a switch route 87 to either one of a catch tray 131 and an auxiliary catch tray 132. On the other hand, the housing 72 is provided with a horizontal route 81, correction routes 83 and 84, a connection route 85 and a switching circuit 86. The horizontal route 81 is provided with rollers 95 which convey a sheet P in the horizontal direction. The connection route 85 connects between the correction route 83 and the correction route 84, and is provided with rollers 92 which convey a sheet P from the correction route 83 to the correction route 84. The correction route 83 is provided with rollers 91 and a decurler 111A to which a sheet P is conveyed by the rollers 91. The correction route 84 is provided with a decurler 111B and rollers 93 which convey a sheet P from the decurler 111B to the switching circuit 86. The switching circuit 86 switches the conveying direction of a sheet P to switchingly convey a sheet P to either the horizontal route 81 or the paper discharge route 82 from the correction route 84.

The decurler 111A is provided with an upstream roller 121A, a correction unit 122A, a downstream roller 123A and the like. The decurler 111B is provided with an upstream roller 121B, a correction unit 122B, a downstream roller 123B and the like. Meanwhile, the decurlers 111A and 111B are collectively referred to simply as the decurler 111. Also, the upstream rollers 121A and 121B are collectively referred to simply as the upstream roller 121. Furthermore, the correction units 122A and 122B are collectively referred to simply as the correction unit 122. Furthermore, the downstream rollers 123A and 123B are collectively referred to simply as the downstream roller 123.

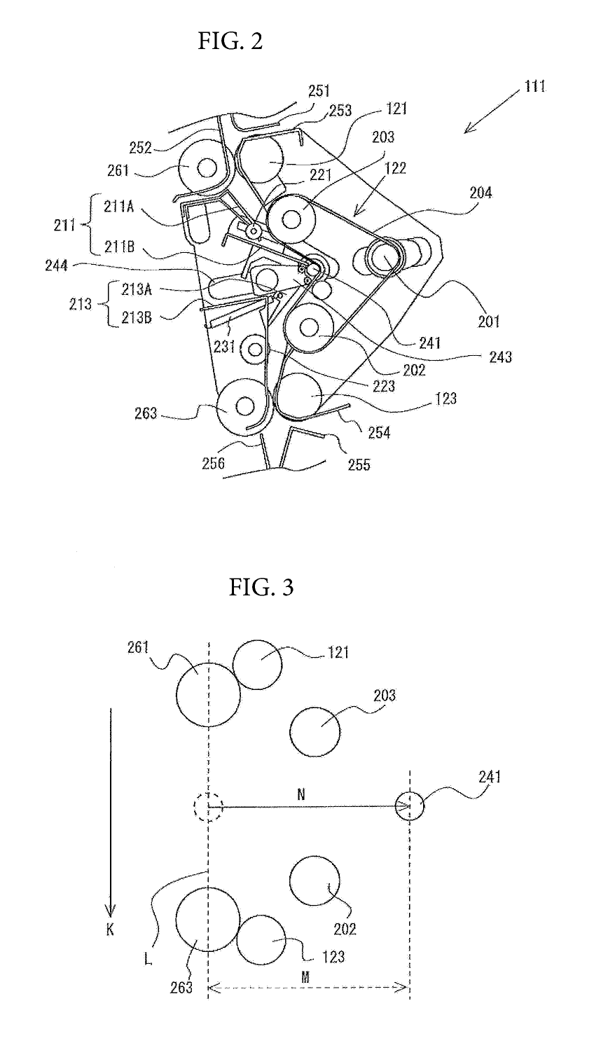

FIG. 2 is a view for showing an exemplary structure of the decurler 111 in detail. As shown in FIG. 2, the decurler 111 is provided with an endless belt 204, a pushing shaft 241, an upstream guide 211 and a downstream guide 213. The endless belt 204 is wound around a drive roller 202 and at least one driven roller 203 and supported at three points by these rollers 202 and 203 and a support roller 201. The driven roller 203 is a roller which rotates following the rotation of the drive roller 202. The pushing shaft 241 is arranged to push the endless belt 204, and the motion amount of the pushing shaft 241 is adjusted by an adjustment member 243. The adjustment member 243 adjusts the motion amount of the pushing shaft 241 along an oblong hole 244 between a lower limit and an upper limit in accordance with the profile of the oblong hole 244. The adjustment member 243 is arranged to push the pushing shaft 241 onto a location of the outer peripheral surface of the endless belt 204 where a tension is applied between the drive roller 202 and the driven roller 203.

The upstream guide 211 is located in the upstream side of the pushing shaft 241 to guide a sheet P between the endless belt 204 and the pushing shaft 241, and provided with an upstream movable guide 211B and an upstream fixed guide 211A. The upstream movable guide 211B follows the motion of the pushing shaft 241. The upstream fixed guide 211A is arranged in the upstream side of the upstream movable guide 211B to cover the upstream side of the upstream movable guide 211B. The downstream guide 213 is located in the downstream side of the pushing shaft 241 to guide a sheet P in the downstream direction from the endless belt 204. The downstream guide 213 is provided with a downstream fixed guide 213B and an downstream movable guide 213A. The downstream movable guide 213A is arranged in the upstream side of the downstream fixed guide 213B to cover the upstream side of the downstream fixed guide 213B to follow the motion of the pushing shaft 241. The downstream movable guide 213A is provided with an urging member 231. The urging member 231 urges the downstream side of the downstream movable guide 213A to the upstream side of the downstream fixed guide 213B. The urging member 231 may be any member which can generate an urging force. The urging member 231 is formed for example of a coil spring, a plate spring, a spiral spring or the like metallic member. Alternatively, the urging member 231 may be made of an elastic resin material.

The upstream roller 121 is arranged in the upstream side of the upstream fixed guide 211A to convey a sheet P. An upstream guide roller 261 is provided opposite to the upstream roller 121. The upstream guide roller 261 rotates while being opposite to and in contact with the upstream roller 121. A guide plate 252 is arranged in a peripheral location of the upstream guide roller 261. Also, a guide plate 251 is arranged opposite to the guide plate 252 and in the upstream side of the upstream roller 121. Furthermore, a guide plate 253 is arranged opposite to the guide plate 252 in a peripheral location of the upstream roller 121. A sheet P is guided by the upstream guide 211 with the guide plates 251 to 253, the upstream guide roller 261 and the upstream roller 121. The upstream guide 211 is provided with an upstream guide roll 221. Specifically, the upstream guide roll 221 is arranged to protrude into a conveyance space formed by the upstream fixed guide 211A and the upstream movable guide 211B, and rotates, while being in contact with a sheet P, when the sheet P is conveyed.

The downstream roller 123 is arranged in the downstream side of the downstream movable guide 213A to convey a sheet P. A downstream guide roller 263 is provided opposite to the downstream roller 123. The downstream guide roller 263 rotates while being opposite to and in contact with the downstream roller 123. The downstream fixed guide 213B has a downstream end portion in a peripheral location of the downstream guide roller 263. A guide plate 256 is arranged in the downstream side of the downstream end portion of the downstream fixed guide 213B. Also, a guide plate 255 is arranged opposite to the guide plate 256 in the downstream side of the downstream roller 123. Furthermore, a guide plate 254 is arranged opposite to the downstream fixed guide 213B in the upstream side of the guide plate 255 and in a peripheral location of the downstream roller 123. A sheet P is guided further in the downstream side of the downstream guide 213 with the guide plates 254 to 256, the downstream roller 123 and the downstream guide roller 263. The downstream guide 213 is provided with a downstream guide roll 223. Specifically, the downstream guide roll 223 is arranged to protrude into a conveyance space formed by the downstream movable guide 213A and the downstream fixed guide 213B, and rotates, while being in contact with a sheet P, when the sheet P is conveyed.

FIG. 3 is a view for explaining the pushing amount M of the pushing shaft 241. As shown in FIG. 3, the pushing amount M of the pushing shaft 241 corresponds to the displacement of the pushing shaft 241 as an absolute value along the pushing direction N perpendicular to a virtual conveying direction K. Namely, the pushing amount M of the pushing shaft 241 is determined with a virtual conveying plane L along the virtual conveying direction K as a reference plane based on the displacement of the pushing shaft 241 from the virtual conveying plane L along the pushing direction N. Incidentally, since the actual route is not straight such as in the virtual conveying direction K, the plane along a line connecting the centers of the upstream guide roller 261 and the downstream guide roller 263 at the shortest distance can be used as the reference plane. Also, the curvature radius R″ given to a sheet P varies depending upon the diameter of the pushing shaft 241. Furthermore, since the pushing shaft 241 pushes a sheet P in the pushing direction N perpendicular to the virtual conveying direction K, when the sheet P is introduced to the decurler 111, the sheet P is necessarily guided along the upstream movable guide 211B in the downstream side of the upstream fixed guide 211A.

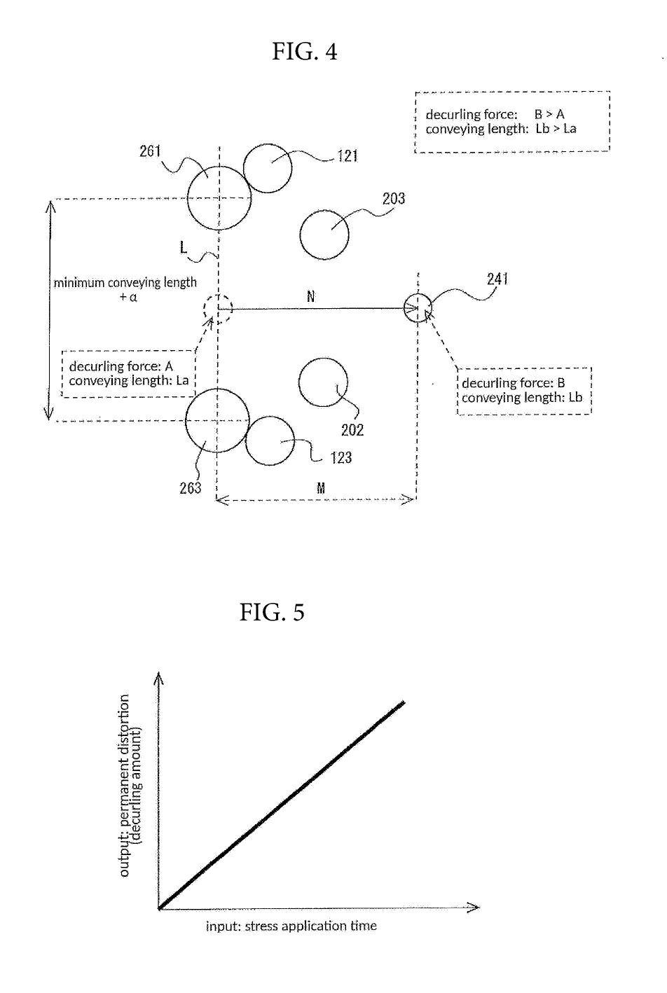

FIG. 4 is a view for explaining the correlation between decurling force and the conveying length of a sheet P. As shown in FIG. 4, the decurling force increases as a sheet P is conveyed. For example, in the case where the conveying length of a sheet P increases from La to Lb, the decurling force increases from A to B. Incidentally, with respect to the upstream guide roller 261 and the downstream guide roller 263 which are referred to as a reference for the pushing amount M of the pushing shaft 241, it is preferred to secure the distance between the upstream guide roller 261 and the downstream guide roller 263 as the minimum conveying length plus α.

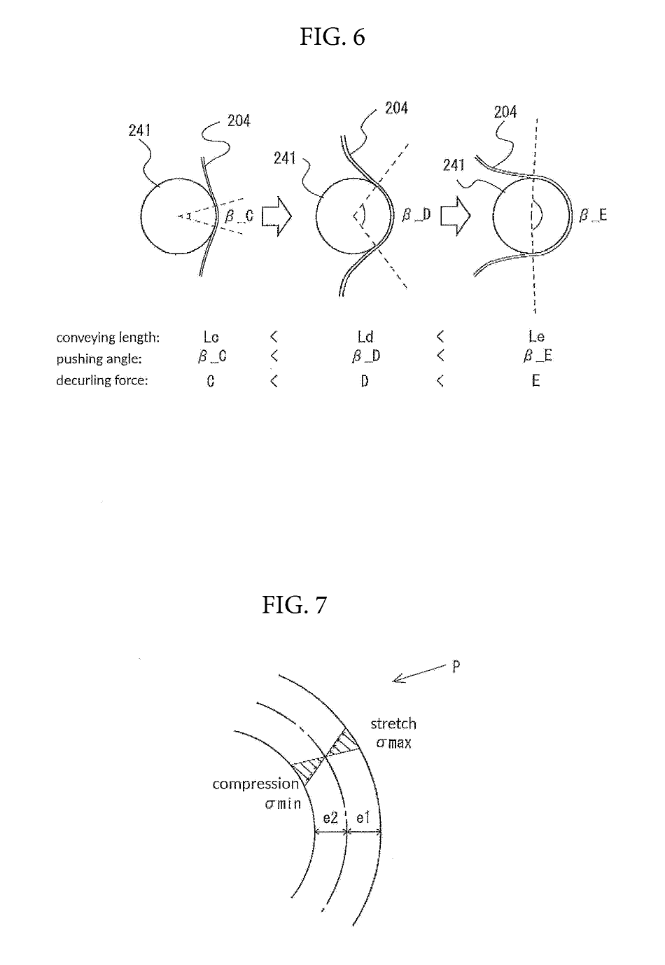

FIG. 5 is a view for explaining the correlation between decurling amount and stress application time. As shown in FIG. 5, the decurling amount which gives a permanent distortion to a sheet P increases as the stress application time increases. Meanwhile, in FIG. 5, it is assumed that the pushing angle β of the pushing shaft 241 is variable, and that the pushing shaft 241 is displaced at a constant speed. Also, the decurling amount varies in accordance with the winding length of a sheet P around the pushing shaft 241 when the sheet P is passed between the pushing shaft 241 and the endless belt 204. FIG. 6 is a view for explaining the condition of the endless belt 204 which is bent by the pushing shaft 241. As shown in FIG. 6, while the conveying length successively increases as Lc, Ld to Le, the pushing angle β successively increases as β_C, β_D to β_E. Since the bending angle of the endless belt 204 increases as the pushing angle β increases, the decurling amount of a sheet P increases. Accordingly, while the pushing angle β increases, the decurling force increases as C, D to E. FIG. 7 is a view for explaining the bending stress σ applied to a sheet P by the pushing shaft 241. As shown in FIG. 7, the greater the amount of deformation becomes between the inside and outside of a sheet P, the stronger the bending stress σ applied to the sheet P becomes. In other words, since the differential distortion amount between the inside and outside of a sheet P increases as the diameter of the pushing shaft 241 wound around the sheet P decreases, the bending stress σ applied to the sheet P changes as well as the curvature radius R″ depending upon the diameter of the pushing shaft 241.

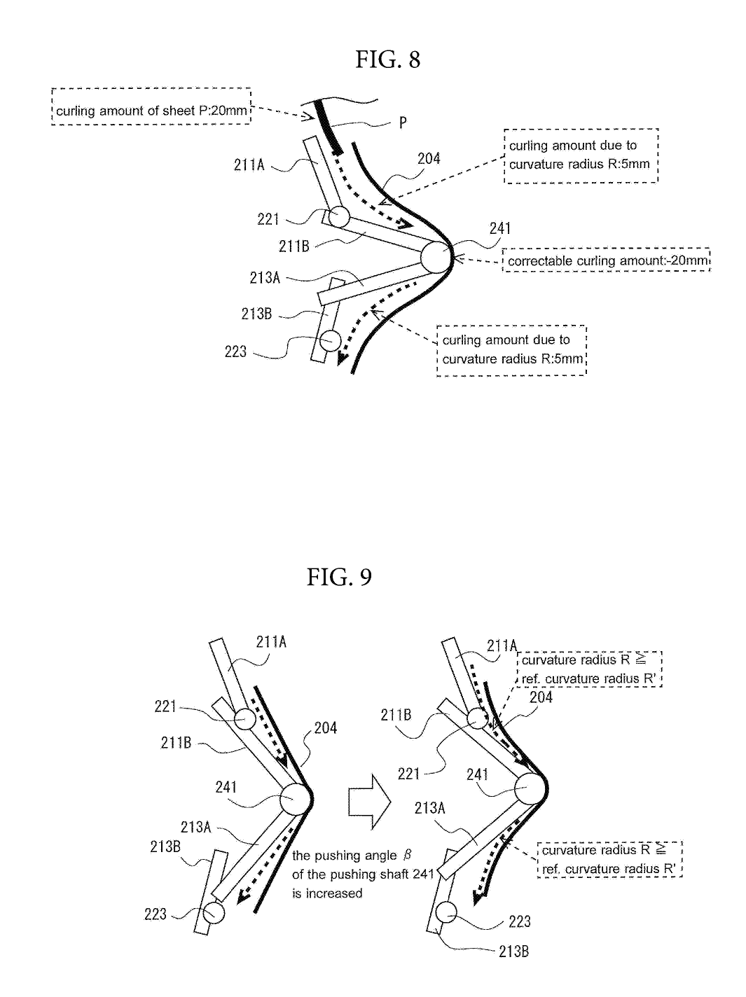

FIG. 8 is a schematic diagram for showing the positional relationship among the upstream guide 211, the downstream guide 213 and the pushing shaft 241 in the case where the curvature radius R of the conveying route of a sheet P is smaller than a reference curvature radius R′. As shown in FIG. 8, in the case where the curling amount of a sheet P is 20 mm, the curling amount to be corrected is 20 mm so that it is considered that the correction curling amount of the pushing shaft 241 can be set to −20 mm. However, the curling amount due to the curvature radius R of the conveying route formed by the upstream guide 211 is 5 mm, and the curling amount due to the curvature radius R of the conveying route formed by the downstream guide 213 is also 5 mm. In this case, the total curling amount is calculated as the curling amount of a sheet P+the curling amount due to the curvature radius R of the upstream guide 211+the correction curling amount+the curvature radius R of the downstream guide 213=20+5−20+5=10 mm. Accordingly, after passing the decurler 111, the curling amount of the sheet P becomes 10 mm. In other words, if the curvature radius R of the conveying route of a sheet P decreases, a bending stress σ is applied to the sheet P so that the sheet P is curled in the opposite direction to the curling direction in which the sheet P is corrected by the decurler 111, and therefore it is not possible to obtain performance which is expected by the use of the decurler 111. Because of this, for the purpose of controlling the curling amount as desired, it is preferred to increase the curvature radius R of the conveying route of a sheet P greater than or equal to the reference curvature radius R′. Meanwhile, in the case where the curling amount for correction is adjusted by predicting the curling amount which is given due to the curvature radius R of the conveying route of a sheet P, the pushing angle β of the pushing shaft 241 is increased vainly. In this case, since a bending stress σ is to be excessively applied to a sheet P, a motor torque or a pressing load is required to move the pushing shaft 241 so that the cost of controlling the decurler 111 becomes high.

FIG. 9 is a schematic diagram for showing variation examples of the positional relationship among the upstream guide 211, the downstream guide 213 and the pushing shaft 241 in relation to the pushing angle β. As shown in FIG. 9, when the pushing angle β of the pushing shaft 241 is increased, it is preferred to control the pushing amount M of the pushing shaft 241 in order that the curvature radius R of the conveying route of a sheet P is greater than or equal to the reference curvature radius R′.

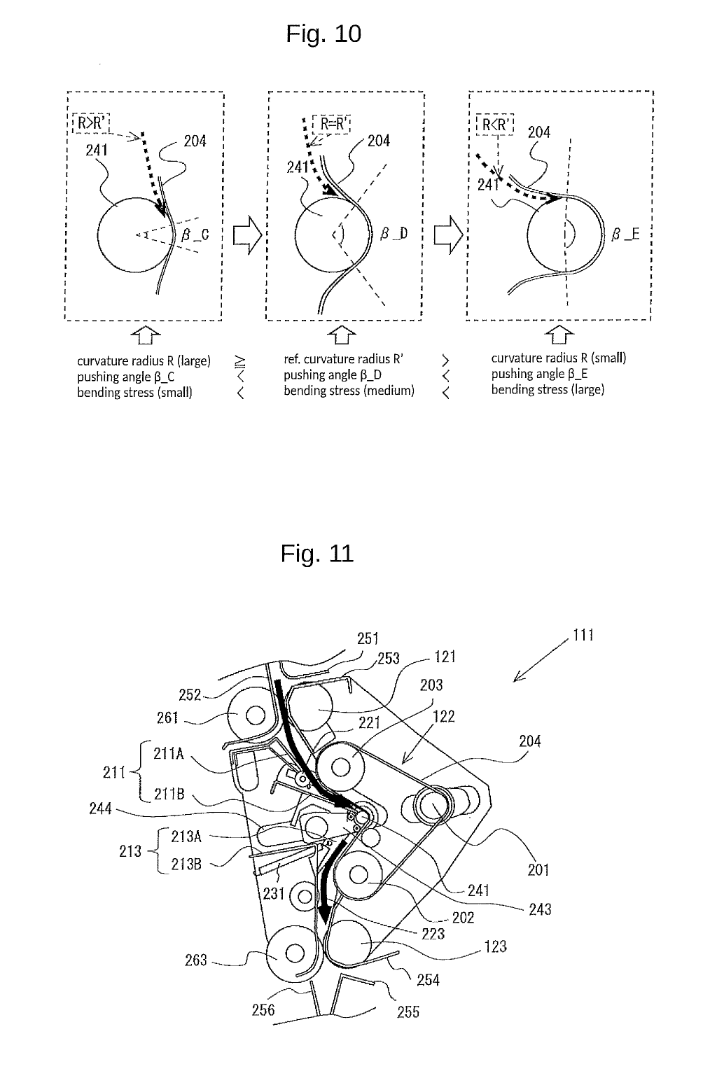

FIG. 10 is a view for schematically explaining the correlation among the curvature radius R of the conveying route of a sheet P, the pushing angle β and the bending stress σ applied to the sheet P. As shown in FIG. 10, as long as the curvature radius R of the conveying route of a sheet P is greater than or equal to the reference curvature radius R′, such a bending stress σ shall not be applied to the sheet P as a permanent distortion is caused of the sheet P. Specifically, since a sheet P is made of intertwined fibers, i.e., so-called an elasto-visco-plastic material, even if curl is unintentionally given to the sheet P in the conveying route of the sheet P, the bending stress σ applied to the sheet P causes only transient distortion so that it is possible to control the curling amount of the sheet P by the pushing shaft 241 in an intended manner. On the other hand, if the curvature radius R of the conveying route of a sheet P is smaller than the reference curvature radius R′, a bending stress σ is applied to the sheet P to change the intertwined state of fibers of the sheet P and form a permanent distortion so that the sheet P cannot resume its profile. Namely, curl is unintentionally given to a sheet P due to the curvature radius R of the conveying route of the sheet P, it is not possible to control the curling amount of the sheet P by the pushing shaft 241 in an intended manner.

In other words, the curvature radius R of the conveying route of a sheet P which is guided by the upstream guide 211 or the downstream guide 213 is set to a value which is greater than or equal to the reference curvature radius R′ in accordance with the sheet P. The reference curvature radius R′ is set in accordance with a sheet P as a threshold value of whether or not a bending stress σ is applied to form a permanent distortion in the sheet P by the conveying route of the sheet P. If the curvature radius R of the conveying route of a sheet P is greater than or equal to the reference curvature radius R′, curl is prevented from being generated by the conveying route of the sheet P.

The curvature radius R of the conveying route of a sheet P is determined based on an upstream virtual curve passing through an upstream contact between the pushing shaft 241 and the sheet P and a nip between the upstream roller 121 and the upstream guide roller 261. More specifically, the curvature radius R of the conveying route of a sheet P is defined between two points, i.e., an upstream contact between the pushing shaft 241 and the sheet P and a nip between the upstream roller 121 and the upstream guide roller 261. The sheet P comes in contact with at least one of the guide plates 251 to 253 therebetween.

The curvature radius R of the conveying route of a sheet P is determined based on a downstream virtual curve passing through a downstream contact between the pushing shaft 241 and the sheet P and a nip between the downstream roller 123 and the downstream guide roller 263. More specifically, the curvature radius R of the conveying route of a sheet P is defined between two points, i.e., a downstream contact between the pushing shaft 241 and the sheet P and a nip between the downstream roller 123 and the downstream guide roller 263. The sheet P comes in contact with at least one of the guide plates 254 to 256 therebetween.

In other words, the curvature radius R of the conveying route of a sheet P is defined based on the upstream virtual curve and the downstream virtual curve, and determined based on the motion amount of the pushing shaft 241 and the motion amounts of the upstream movable guide 211B and the downstream movable guide 213A. Meanwhile, for example, if the paper density of the sheet P is 350 gsm, the reference curvature radius R′ is preferably 50.

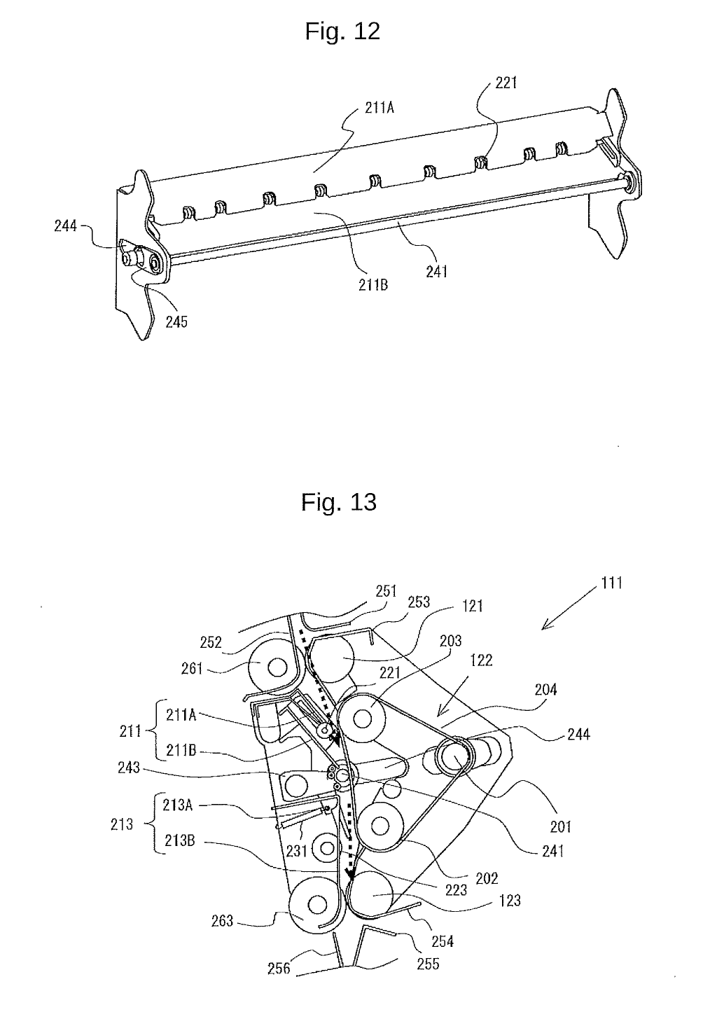

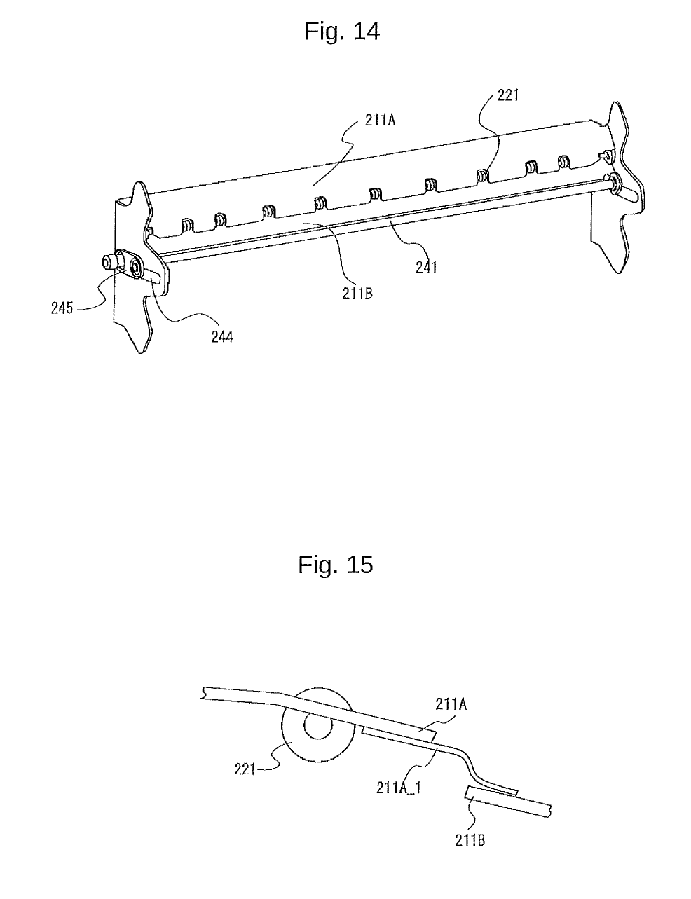

FIG. 11 is a side view for showing the positional relationship among the upstream guide 211, the downstream guide 213 and the pushing shaft 241 when the pushing angle β of the pushing shaft 241 is 100°. FIG. 12 is a perspective view for showing the positional relationship among the upstream fixed guide 211A, the downstream movable guide 213A and the pushing shaft 241 when the pushing angle β of the pushing shaft 241 is 100°. FIG. 13 is a side view for showing the positional relationship among the upstream guide 211, the downstream guide 213 and the pushing shaft 241 when the pushing angle β of the pushing shaft 241 is 12°. FIG. 14 is a perspective view for showing the positional relationship among the upstream fixed guide 211A, the downstream movable guide 213A and the pushing shaft 241 when the pushing angle β of the pushing shaft 241 is 12°. As illustrated in FIG. 11 through FIG. 14, as the pushing angle β increases, the bending stress σ applied to a sheet P increases. However, as the pushing angle β increases, the curvature radius R of the conveying route of a sheet P decreases. The curvature radius R of the conveying route of a sheet P is thereby set to the reference curvature radius R′. Incidentally, as illustrated in FIG. 12 and FIG. 14, it is preferred to provide a plurality of the upstream guide rolls 221 and a plurality of the downstream guide rolls 223 in the direction arranged perpendicular to the conveying direction of a sheet P.

FIG. 15 is a schematic view for showing an example in which a resin guide 211A_1 is provided at the downstream end portion of the upstream fixed guide 211A. As shown in FIG. 15, the resin guide 211A_1 functions as part of the upstream fixed guide 211A to guide a sheet P to the upstream movable guide 211B. Namely, the resin guide 211A_1 can be any member capable of covering the upstream side of the upstream movable guide 211B.

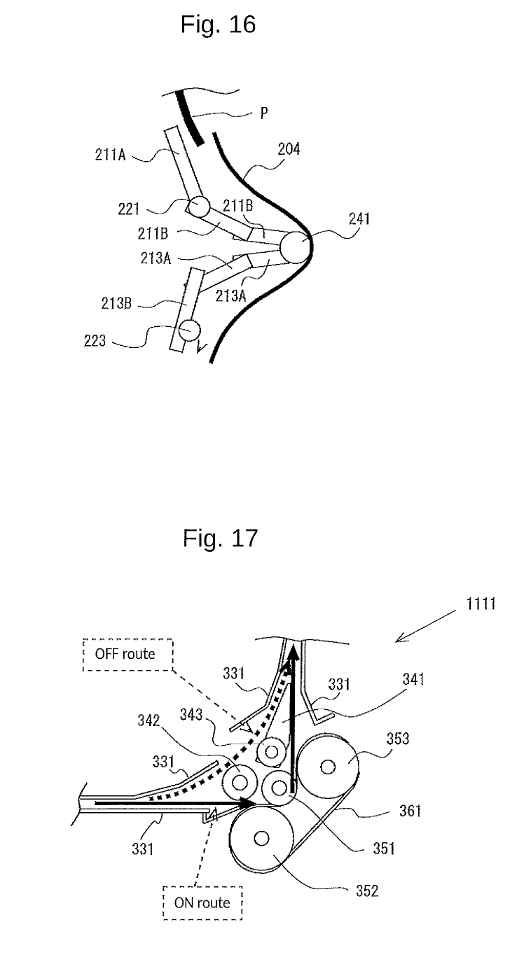

FIG. 16 is a schematic view for showing an example in which are provided a plurality of upstream movable guides 211B and a plurality of downstream movable guides 213A. As shown in FIG. 16, there may be arranged a plurality of the upstream movable guides 211B and a plurality of the downstream movable guides 213A respectively. In short, the upstream guide 211 and the downstream guide 213 can be any members capable of deforming the conveying route of a sheet P to follow the motion of the pushing shaft 241. Also, even if the conveying route of a sheet P is deformed by the upstream guide 211 and the downstream guide 213, the curvature radius R of the conveying route of a sheet P has to be greater than or equal to the reference curvature radius R′.

As has been discussed above, in accordance with the image forming system 1 of the above embodiment, the finisher 7 includes the upstream fixed guide 211A which is arranged in the upstream side of the upstream movable guides 211B to cover the upstream side of the upstream movable guide 211B, and the upstream guide 211 and downstream guide 213 which are arranged to guide a sheet P in order that the curvature radius R of the conveying route of the sheet P is set to a value which is greater than or equal to the reference curvature radius R′ in accordance with the sheet P. The reference curvature radius R′ in accordance with the sheet P is set as a threshold value of whether or not a bending stress σ is applied to form a permanent distortion in the sheet P by the conveying route of the sheet P. Accordingly, since the upstream fixed guide 211A covers the upstream movable guide 211B, the sheet P guided by the upstream guide 211 is not caught by the conveying route of the sheet P during conveyance. Furthermore, since the curvature radius R of the conveying route of a sheet P is greater than or equal to the reference curvature radius R′, undesired curl is not formed of the sheet P during conveyance. Accordingly, the paper conveying performance and the decurl performance of a sheet P can be improved.

Also, in accordance with the image forming system 1 of the above embodiment, the curvature radius R of the conveying route of a sheet P is determined based on an upstream virtual curve passing through an upstream contact between the pushing shaft 241 and the sheet P and a nip between the upstream roller 121 and the upstream guide roller 261. The curvature radius R of the conveying route of the sheet P can thereby be adjusted in accordance with the position of the pushing shaft 241.

On the other hand, in accordance with the image forming system 1 of the above embodiment, there may be formed burrs of the metallic plate or resin lib in the conveyance surface of the upstream fixed guide 211A and upstream movable guide 211B. The upstream guide roll 221 is arranged to protrude into the conveyance space formed by the upstream fixed guide 211A and the upstream movable guide 211B. Accordingly, when a sheet P is guided from the upstream fixed guide 211A to the upstream movable guide 211B by the upstream guide roll 221, it is unlikely that the image formation surface of the sheet P directly touches the conveyance surface formed by the upstream fixed guide 211A and the upstream movable guide 211B. It is therefore possible to reduce the chance that scratches are made on an image formed on a sheet P which is conveyed by the upstream guide 211.

Furthermore, in accordance with the image forming system 1 of the above embodiment, the finisher 7 includes the downstream movable guides 213A which is arranged in the upstream side of the downstream fixed guide 213B to cover the upstream side of the downstream fixed guide 213B. Accordingly, a sheet P guided by the downstream guide 213 is not caught by the conveying route of the sheet P during conveyance. The paper conveying performance of the sheet P guided by the downstream guide 213 can thereby be improved.

Furthermore, in accordance with the image forming system 1 of the above embodiment, the curvature radius R of the conveying route of a sheet P in the finisher 7 is determined based on the upstream virtual curve and the downstream virtual curve passing through a downstream contact between the pushing shaft 241 and the sheet P and a nip between the downstream roller 123 and the downstream guide roller 263, and determined based on the motion amount of the pushing shaft 241 and the motion amounts of the upstream movable guide 211B and the downstream movable guide 213A. The positions of the pushing shaft 241, the upstream movable guide 211B and the downstream movable guide 213A can be easily controlled. It is therefore possible to easily control the curvature radius R of the conveying route of a sheet P in the finisher 7 to be greater than or equal to the reference curvature radius R′ in accordance with the conveyed sheet P, and therefore to control the curvature radius R of the conveying route of the sheet P at a low cost.

Furthermore, in accordance with the image forming system 1 of the above embodiment, the finisher 7 includes the urging member 231 which urges the downstream side of the downstream movable guide 213A against the upstream side of the downstream fixed guide 213B. Because of this, there is no clearance between the downstream side of the downstream movable guide 213A and the upstream side of the downstream fixed guide 213B. It is therefore possible to prevent a sheet P from being caught by the conveying route of the sheet P during conveyance from the downstream movable guide 213A to the downstream fixed guide 213B, and therefore to significantly improve the paper conveying performance of the sheet P conveyed by the downstream guide 213.

Furthermore, in accordance with the image forming system 1 of the above embodiment, there may be formed burrs of the metallic plate or resin lib in the conveyance surface of the downstream movable guide 213A and downstream fixed guide 213B. The downstream guide roll 223 is arranged to protrude into a conveyance space formed by the downstream movable guide 213A and the downstream fixed guide 213B. Accordingly, when a sheet P is guided from the downstream movable guide 213A to the downstream fixed guide 213B by the downstream guide roll 223, it is unlikely that the image formation surface of the sheet P directly touches the conveyance surface formed by the downstream movable guide 213A and the downstream fixed guide 213B. It is therefore possible to reduce the chance that scratches are made on an image formed on a sheet P which is conveyed by the downstream fixed guide 213.

Meanwhile, FIG. 17 is a view for showing an exemplary structure of a conventional decurler 1111. As shown in FIG. 17, the decurler 1111 is provided with guide plates 331, a switching plate 341, guide rolls 342 and 343, a pushing shaft 351, a driven roller 352, a drive roller 353 and an endless belt 361. The endless belt 361 is wound around the drive roller 353 and the driven roller 352 and pushed by the pushing shaft 351 to form a nip for correcting a sheet P. The position of the pushing shaft 351 is fixed, and cannot be changed. The switching plate 341 serves to switch the conveying direction of a sheet P to either an ON route or an OFF route. Accordingly, the curling amount of a sheet P is not controlled in a stepwise manner.

Contrary to this, in accordance with the image forming system 1 of the above embodiment, the finisher 7 includes the adjustment member 243 which adjusts the motion amount of the pushing shaft 241 between a lower limit and an upper limit, and pushes the pushing shaft 241 into a location of the outer peripheral surface of the endless belt 204 where a tension is applied between the drive roller 202 and the driven roller 203. The motion amount of the pushing shaft 241 can be adjusted between the lower limit and the upper limit by pushing the pushing shaft 241 into the outer peripheral surface of the endless belt 204. Accordingly, since the pushing amount M of the pushing shaft 241 can be adjusted in multiple steps, it is possible to control the curling amount for correcting a sheet P in multiple steps.

The image forming unit 1 have been explained based on the embodiments in accordance with the present invention. However, it is not intended to limit the present invention to the precise form described, and obviously many modifications and variations are possible without departing from the spirit and scope of the invention.

For example, while the endless belt 204 is supported at three points, i.e., the drive roller 202, the driven roller 203 and the support roller 201 in the case of the above embodiment, the present invention is not limited thereto. For example, the endless belt 204 can be supported at two points excluding the support roller 201, or at four or more points, i.e., at least one of the driven roller 203 and the support roller 201 is plural.

Although embodiments of the present invention have been described and illustrated in detail, the disclosed embodiments are made for purposes of illustration and example only and not limitation. The scope of the present invention should be interpreted by terms of the appended claims.

What is claimed is:

1. A finisher which corrects curl of a sheet with a decurler which comprises:
an endless belt;
a pushing shaft which pushes the endless belt;
an upstream guide which is located in an upstream side of the pushing shaft to guide the sheet between the endless belt and the pushing shaft; and
a downstream guide which is located in a downstream side of the pushing shaft to guide the sheet in the downstream direction from the endless belt,
the upstream guide comprising:
an upstream movable guide which follows motion of the pushing shaft; and
an upstream fixed guide which is arranged in an upstream side of the upstream movable guide to cover the upstream side of the upstream movable guide, wherein
a curvature radius of a conveying route of the sheet which is guided by each of the upstream guide and the downstream guide is set to a value which is greater than or equal to a reference curvature radius in accordance with the sheet, and wherein
the reference curvature radius is set in accordance with the sheet as a threshold value of whether or not a bending stress is applied to form a permanent distortion in the sheet by the conveying route of the sheet.

2. The finisher of claim 1 further comprising:
an upstream roller which is arranged in an upstream side of the upstream fixed guide to convey the sheet; and
an upstream guide roller which rotates while being opposite to and in contact with the upstream roller, wherein
the curvature radius of the conveying route of the sheet is determined based on an upstream virtual curve passing through an upstream contact between the pushing shaft and the sheet and a nip between the upstream roller and the upstream guide roller.

3. The finisher of claim 1 further comprising:
an upstream guide roll which is arranged to protrude into a conveyance space formed by the upstream fixed guide and the upstream movable guide, and rotates, while being in contact with the sheet, when the sheet is conveyed.

4. The finisher of claim 1 wherein
the downstream guide is provided with a downstream fixed guide and a downstream movable guide which is arranged in an upstream side of the downstream fixed guide to cover the upstream side of the downstream fixed guide to follow the motion of the pushing shaft.

5. The finisher of claim 4 further comprising:
a downstream roller is arranged in a downstream side of the downstream movable guide to convey the sheet; and
a downstream guide roller which rotates while being opposite to and in contact with the downstream roller, wherein
the curvature radius of the conveying route of the sheet is determined based on a downstream virtual curve passing through a downstream contact between the pushing shaft and the sheet and a nip between the downstream roller and the downstream guide roller, and determined based on a motion amount of the pushing shaft and motion amounts of the upstream movable guide and the downstream movable guide.

6. The finisher of claim 4 further comprising:
an urging member which urges a downstream side of the downstream movable guide to the upstream side of the downstream fixed guide.

7. The finisher of claim 4 further comprising:
a downstream guide roll is arranged to protrude into a conveyance space formed by the downstream movable guide and the downstream fixed guide, and rotates, while being in contact with the sheet, when the sheet is conveyed.

8. The finisher of claim 1 further comprising:
a drive roller;
at least one driven roller which rotates following rotation of the drive roller; and
an adjustment member which adjusts a motion amount of the pushing shaft, wherein
the endless belt is wound around the drive roller and the driven roller, and wherein
the adjustment member adjusts a motion amount of the pushing shaft between a lower limit and an upper limit, and pushes the pushing shaft into a location of the outer peripheral surface of the endless belt where a tension is applied between the drive roller and the driven roller.

9. An image forming system comprising:
an image forming apparatus; and
the finisher recited in claim 1 and arranged in a downstream side of the image forming apparatus.
